(19) United States
(12) Patent Application Publication
(10) Pub. No.: US 2004/0041301 A1
(43) Pub. Date: Mar. 4, 2004

(54) Method for transforming municipal solid waste into useful material

(76) Inventors: Floyd E. Bouldin, McMinnville, TN (US); Thomas E. Cantrell, McMinnville, TN (US)

Correspondence Address: STITES & HARBISON, PLLC, 400 W MARKET ST, SUITE 1800, LOUISVILLE, KY, 40202-3352, US

(21) Appl. No.: 10/232,432

(22) Filed: Aug. 30, 2002

(51) Int. Cl. B29C 47/00

(52) U.S. Cl. 264/211; 264/349

(57) ABSTRACT

A method of thermodynamically reducing and converting municipal solid waste into useful end products capable of being recycled and reused or otherwise transformed into useful articles. The method comprises the steps of: providing a quantity of municipal solid waste having a first volume and a liquid content; preprocessing the municipal solid waste having the first volume and liquid content into a second volume of municipal solid waste wherein the second volume is smaller than the first volume; inserting the second volume of municipal solid waste into a hydrolyzer; processing the municipal solid waste within the hydrolyzer when the hydrolyzer has a steam filled outer jacket at a prescribed pressure and temperature; and removing the processed municipal solid waste from the interior of the hydrolyzer.

### BACKGROUND OF THE INVENTION

1. Field of the Invention

The present invention relates generally to municipal solid waste disposal, and municipal solid waste reclamation and recycling. Municipal solid waste (hereinafter “solid waste”) disposal can be generally defined as the disposal of normally solid or semi-solid materials resulting from human and animal activities that are useless and unwanted and not hazardous or toxic. Solid wastes may be further classified in two groups: “garbage” which is decomposable wastes from food; and “rubbish” which is decomposable wastes, either combustible (such as paper, wood, and cloth) or non-combustible (such as metal, glass, plastics and ceramics).

The present invention is primarily directed to a method of reducing and converting (hereinafter “processing”) solid waste comprised of garbage and rubbish (hereinafter “municipal solid waste” or “MSW”) into useful material or articles.

2. Description of the Related Art

By far the most common method of solid waste disposal in the United States is the deposition of such wastes on land or in “landfills”. Landfills are believed to account for more than ninety percent of the nation's municipal refuse and incineration accounts for most of the remainder. Composting of solid wastes accounts for only an insignificant amount. Historically, a municipality's chosen disposal method depended almost entirely on costs, and more recently environmental conditions, both of which are likely to reflect the local circumstances.

Until now, a sanitary landfill was considered the cheapest most satisfactory means of disposal, but only if suitable land is within an “economic range” of the source of the wastes (i.e., geographic proximity making waste removal and hauling economically feasible). Collection and transportation costs are known to account for seventy-five percent of the total cost of solid waste disposal and management.

In modern landfills the refuse is spread in thin layers, each of which is compacted by heavy industrial equipment before the next layer is spread. When about ten feet of refuse has been deposited, it is covered by a thin layer of clean earth which also is compacted. Pollution of surface and groundwater is believed to be minimized by lining and contouring the fill, compacting and planting the cover, selecting proper soil, diverting upland drainage, and placing wastes in sites not subject to flooding or high groundwater levels. Landfills are known to generate flammable gases through the anaerobic decomposition of the organic solid waste and thus proper venting and burning of the gases, usually methane, is often necessary to eliminate or alleviate potentially dangerous conditions.

The second most popular method of solid waste disposal is incineration. Incinerators of conventional design burn refuse on moving grates in refractory-lined chambers. The combustible gases and the solids they carry are burned in secondary chambers. Combustion is eighty-five to ninety percent complete for the combustible materials. In addition to heat, the products of incineration include the normal primary products of combustion including carbon dioxide and water, as well as oxides of sulfur and nitrogen and other gaseous pollutants. The nongaseous products are fly ash and unburned solid residue. Emissions of fly ash and other particles are often controlled by wet scrubbers, electrostatic precipitators, and bag filters positioned inside or adjacent the exhaust stacks.

On the downside, landfill and incineration methods of disposal have been known to pose significant environmental problems and health concerns by the municipality, government, private industry, and individuals are on the rise. Therefore, a growing trend associated with the treatment and handling of solid waste material is “resource recovery”. Resource recovery is intended to recover useful materials from raw municipal solid waste and the handling may include grinding or shredding machines, magnetic separators, air classification that separates the light and heavy fractions, screening, and/or washing. Resource recovery methods, therefore, attempt to reduce (i.e., recycle) the solid waste into a more manageable, although not always useful, form, but such methods are quite costly.

In all known methods of solid waste disposal (e.g., reduction, treatment or resource recovery), the resultant end product may further include microbes or microorganisms that require careful consideration and handling prior to disposal. In such cases the by-products are believed to remain waste materials not suitable for use or transformation into useful articles. The present invention relates generally to municipal solid waste handling and disposal, but is actually believed to be the most desirable solution to the growing waste problem because the cost effective and resource recovery methods used, and the physical characteristics of the processed material end product.

The art to which the invention relates is limited to and includes the information of the type disclosed in U.S. Pat. No. 6,017,475 granted to Cantrell which is incorporated by reference as if fully set forth herein. The 475 patent is directed to a process of transforming household garbage into useful materials.

### SUMMARY OF THE INVENTION

The preferred preprocessing portion of the present invention preferably includes at least one grinder and at least one shredder or other material reduction apparatus used to reduce the incoming particle size of the household garbage to a more useful particle size, a dewatering press, and a hydrolyzer for metamorphically processing the volume reduced garbage. The preferred bio-reactor is similar in appearance to a conventional hydrolyzer, but the similarities end there.

The raw material to be processed undergoes a preprocessing step in which it is shredded, ground, dewatered prior to insertion into the hydrolyzer for the actual processing (i.e., cooking) step takes place. The resultant shredded and ground material or raw material “cake” is then transferred, either automatically or manually, to a dewatering press in order to uniformly hydrate the material prior to its introduction into the hydrolyzer.

The preferred embodiment of the at least one grinder apparatus is manufactured and sold by Bouldin & Lawson, Inc., of McMinnville, Tenn. The preferred embodiment of the at least one shredder apparatus is distributed by Bouldin & Lawson, Inc., of McMinnville, Tenn. The preferred embodiment of the hydrolyzer apparatus is available from WastAway Services, LLC of McMinnville, Tenn.

The hydrolyzer includes an outer containment vessel having an exterior jacket and an interior pressure vessel. An airspace exists between the interior vessel and the jacket. A heated steam inlet and exit are attached to the jacket and communicate with the air space. When the material cake is introduced into the interior of the hydrolyzer pressure vessel automatically by an inventive gate system, the operator introduces heated stem into the air space surrounding the interior vessel to heat the interior vessel and the material cake inside it. Of course, preheating of the vessel jacket by introducing of steam therein prior to introducing the material cake into the hydrolyzer is also acceptable.

A preferred temperature of the steam in the outer jacket is 350 degrees. Of course, the process of the present invention could be carried out at other temperature and pressures within permissible ranges, but the associated time for completion of the inventive process at other than preferred temperature and pressure will vary significantly. That is, the greater the temperature and pressure in the hydrolyzer, the faster the chemical reactions occur, however a practical maximum temperature and pressure also exists at the preferred levels.

The pressure and temperature, in conjunction with the preprocessed composition of the material cake, acts as the catalyst to speed the chemical reaction of decomposition of the material cake within the vessel. This high temperature and pressure environment causes the material cake to rapidly decompose into its basic constituent elements, and allows them to recombine or remain in their organic cellulose form, and it kills bacteria once living within the material cake.

When the processing is complete, the material cake comprises a sterile aggregate cellulose “fluff”. The aggregate fluff end product is a mixture of cellulose fibers and other elements present in the material cake prior to processing. The aggregate fluff is then dried and preferably remanufactured into useful articles such as compressed bales of fluff or other molded and/or extruded articles. Chemical or natural additives may be added to the fluff to enhance its existing characteristics or add supplemental material characteristics as needed. In any case, the aggregate cellulose fluff can be used to manufacture plasticene cross ties, and building materials such as bricks, boards and blocks, etc.

The present inventive method may, therefore, be summarized in a variety of ways, one of which is the following: a method of transforming municipal solid waste, garbage or rubbish into useful material, comprising the following steps, providing a quantity of municipal solid waste having a first volume and a liquid content, preprocessing the municipal solid waste having the first volume and liquid content into a second volume of municipal solid waste wherein the second volume is smaller than the first volume, inserting the second volume of municipal solid waste into a hydrolyzer, processing the municipal solid waste within the hydrolyzer when the hydrolyzer has a steam filled outer jacket at a prescribed pressure and temperature, and removing the processed municipal solid waste from the interior of the hydrolyzer.

The step of inserting the MSW into the hydrolyzer preferably further includes continuously feeding the preprocessed municipal solid waste into the hydrolyzer in predetermined volumes. Similarly, the step of removing the processed MSW from the hydrolyzer further includes continuously removing the processed municipal solid waste from the hydrolyzer in predetermined volumes. The continuous operations of either feeding or removing the MSW into or out of the hydrolyzer preferably includes the automatic operation of these tasks by machine.

The preprocessing step of the present invention preferably includes extracting the liquid from wet portions of the municipal solid waste and redistributing the liquid to the dry portions of the municipal solid waste to create a substantially uniform hydration level throughout the volume of preprocessed municipal solid waste.

The preferred method of the present invention may also include the following: an optional drying step, extruding the processed municipal solid waste and forming a block thereof, molding the extruded processed municipal solid waste into a block or other useful article, purifying the processed municipal solid waste by removing inorganic materials therefrom, and/or mixing the processed municipal solid waste with a plastic material.

### BRIEF DESCRIPTION OF THE DRAWINGS

FIG. 1 is a flow chart diagram of the various fundamental processing steps associated with the inventive method of the present invention.

### DETAILED DESCRIPTION OF THE PREFERRED EMBODIMENT(S)

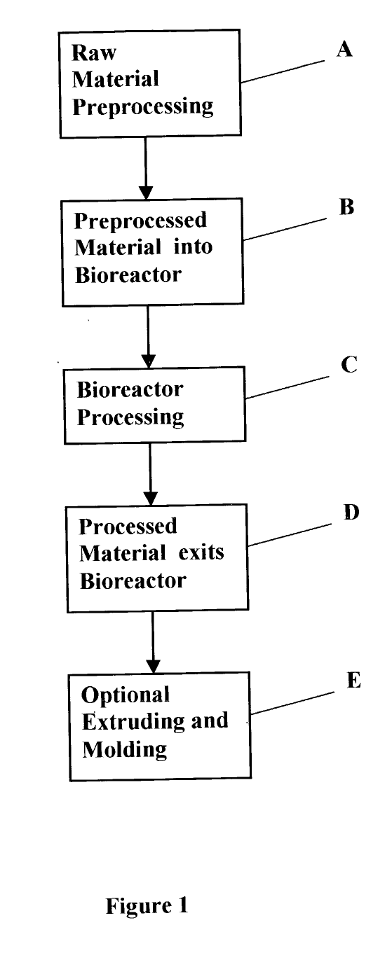

The preferred embodiment of the inventive method is graphically depicted in FIG. 1. The various steps associated with the method can therefore be fundamentally and generally described in the flow chart. The raw material, preferably municipal solid waste (“MSW”) undergoes preprocessing which consists of shredding and grinding it to decrease its original volume and dewatering the shredded and ground material in order to uniformly hydrate the it (please refer to “A” of FIG. 1).

The preprocessed material is then introduced into the hydrolyzer supplied by WastAway Services, LLC of McMinnville, Tenn. The WastAway Services hydrolyzer resembles a conventional hydrolyzer used in the meat and poultry rendering industries to render animal carcasses and parts thereof. The material input system is available from WastAway Services, LLC of McMinnville, Tenn. It allows the input of material continuously while maintaining the interior pressure and temperature of the hydrolyzer (please refer to “B” of FIG. 1).

The preprocessed MSW is then processed within the interior of the hydrolyzer for a given length of time depending upon the user selected temperature and pressure within the steam jacket and hydrolyzer interior. (Please refer to “C” of FIG. 1). The preferred temperature and thus the pressure of the steam jacket is 350 degrees.

After the allotted time within the hydrolyzer has elapsed (i.e., “resident” or “in vessel time”) the material exits the hydrolyzer automatically by operation of the material exit system available from WastAway Services, LLC of McMinnville, Tenn. The exiting material is hot and thus care is taken to capture the material upon exit. (Please refer to “D” of FIG. 1).

The processed material that is captured upon exit of the hydrolyzer can be dried or introduced into an extruding apparatus which in turn, but preferably as a continuous phase, deposits the extruded material into a mold for compressive formation of useful articles or blocks of processed material. (Please refer to “E” of FIG. 1).

What is claimed is:

1. A method of transforming municipal solid waste into useful material, comprising the following steps:
providing a quantity of municipal solid waste having a first volume and a liquid content;
preprocessing the municipal solid waste having the first volume and liquid content into a second volume of municipal solid waste wherein the second volume is smaller than the first volume;
inserting the second volume of municipal solid waste into a hydrolyzer;
processing the municipal solid waste within the hydrolyzer when the hydrolyzer has a steam filled outer jacket at a prescribed pressure and temperature; and
removing the processed municipal solid waste from the interior of the hydrolyzer.

2. The method of claim 1, wherein the inserting step further includes:
continuously feeding the preprocessed municipal solid waste into the hydrolyzer in predetermined volumes.

3. The method of claim 1, wherein the removing step further includes:
continuously removing the processed municipal solid waste from the hydrolyzer in predetermined volumes.

4. The method of claim 2, wherein the step of continuous feeding the preprocessed municipal solid waste into the hydrolyzer further includes:
automatically feeding the preprocessed municipal solid waste into the hydrolyzer.

5. The method of claim 3, wherein the step of continuously removing the processed municipal solid waste from the hydrolyzer further includes:
automatically removing the processed municipal solid waste from the hydrolyzer.

6. The method of claim 1, wherein the preprocessing step further includes:
extracting the liquid from wet portions of the municipal solid waste and redistributing the liquid to the dry portions of the municipal solid waste to create a substantially uniform hydration level throughout the volume of preprocessed municipal solid waste.

7. The method of claim 1, wherein the step of processing the municipal solid waste within the hydrolyzer further comprises the step of:
regulating the temperature within the steam jacket of the hydrolyzer to be in the range from of 300 degrees to 400 degrees.

8. The method of claim 7, further including the step of:
regulating the temperature within the hydrolyzer to be 350 degrees.

9. The method of claim 1, wherein the step of processing the municipal solid waste within the hydrolyzer further comprises the step of:
regulating the pressure within the steam jacket of the hydrolyzer to be in the range from 90 psi to 150 psi.

10. The method of claim 9, further including the step of:
regulating the pressure within the steam jacket of the hydrolyzer to be 120.

11. The method of claim 1, further including the step of:
drying the processed municipal solid waste that was removed from the interior of the hydrolyzer.

12. The method of claim 1, wherein the step of removing the processed municipal solid waste from the interior of the hydrolyzer further includes the step of:
extruding the processed municipal solid waste and forming a block thereof.

13. The method of claim 12, wherein the step of extruding the processed municipal solid waste and forming a block thereof further includes the step of:
molding the extruded processed municipal solid waste into a block.

14. The method of claim 11, further including the step of:
purifying the processed municipal solid waste by removing inorganic materials therefrom.

15. The method of claim 11, further including the step of:
mixing the processed municipal solid waste with a plastic material.

16. The method of claim 1, further including the step of:
mixing the processed municipal solid waste removed from the hydrolyzer with a plastic material.

17. The method of claim 15, wherein the step of mixing the processed municipal solid waste with a plastic material further includes the step of:
extruding the mixture to form a useful article.

18. The method of claim 16, wherein the step of mixing the processed municipal solid waste removed from the hydrolyzer with a plastic material further includes the step of:
extruding the mixture to form a useful article.

19. The method of claim 17, wherein the step of extruding the mixture to form a useful article further includes the step of:
molding the extrusion to form a useful article.

20. The method of claim 18, wherein the step of extruding the mixture to form a useful article further includes the step of:
molding the extrusion to form a useful article.

21. A method of transforming garbage or rubbish into useful material, comprising the following steps:
providing a quantity of garbage having a first volume and a liquid content;
preprocessing the garbage having the first volume and liquid content into a second volume of garbage wherein the second volume is smaller than the first volume;
inserting the second volume of garbage into a hydrolyzer;
processing the garbage within the hydrolyzer when the hydrolyzer has a steam filled outer jacket at a prescribed pressure and temperature; and
removing the processed garbage from the interior of the hydrolyzer.

22. The method of claim 21, wherein the inserting step further includes:
continuously feeding the preprocessed garbage into the hydrolyzer in predetermined volumes.

23. The method of claim 21, wherein the removing step further includes:
continuously removing the processed garbage from the hydrolyzer in predetermined volumes.

24. The method of claim 22, wherein the step of continuous feeding the preprocessed garbage into the hydrolyzer further includes:
automatically feeding the preprocessed garbage into the hydrolyzer.

25. The method of claim 23, wherein the step of continuously removing the processed garbage from the hydrolyzer further includes:
automatically removing the processed garbage from the hydrolyzer.

26. The method of claim 21, wherein the preprocessing step further includes:
extracting the liquid from wet portions of the garbage and redistributing the liquid to the dry portions of the garbage to create a substantially uniform hydration level throughout the volume of preprocessed garbage.

27. The method of claim 21, wherein the step of processing the garbage within the hydrolyzer further comprises the step of:
regulating the temperature within the steam jacket of the hydrolyzer to be in the range from of 300 degrees to 400 degrees.

28. The method of claim 27, further including the step of:
regulating the temperature within the hydrolyzer to be 350 degrees.

29. The method of claim 21, wherein the step of processing the garbage within the hydrolyzer further comprises the step of:
regulating the pressure within the steam jacket of the hydrolyzer to be in the range from 90 psi to 150 psi.

30. The method of claim 29, further including the step of:
regulating the pressure within the steam jacket of the hydrolyzer to be 120.

31. The method of claim 21, further including the step of:
drying the processed garbage that was removed from the interior of the hydrolyzer.

32. The method of claim 21, wherein the step of removing the processed garbage from the interior of the hydrolyzer further includes the step of:
extruding the processed garbage and forming a block thereof.

33. The method of claim 32, wherein the step of extruding the processed garbage and forming a block thereof further includes the step of:
molding the extruded processed garbage into a block.

34. The method of claim 31, further including the step of:
purifying the processed garbage by removing inorganic materials therefrom.

35. The method of claim 31, further including the step of:
mixing the processed garbage with a plastic material.

36. The method of claim 21, further including the step of:
mixing the processed garbage removed from the hydrolyzer with a plastic material.

37. The method of claim 35, wherein the step of mixing the processed garbage with a plastic material further includes the step of:
extruding the mixture to form a useful article.

38. The method of claim 36, wherein the step of mixing the processed garbage removed from the hydrolyzer with a plastic material further includes the step of:
extruding the mixture to form a useful article.

39. The method of claim 37, wherein the step of extruding the mixture to form a useful article further includes the step of:
molding the extrusion to form a useful article.

40. The method of claim 38, wherein the step of extruding the mixture to form a useful article further includes the step of:
molding the extrusion to form a useful article.
